(19) United States
(12) Patent Application Publication
(10) Pub. No.: US 2026/0179382 A1
(43) Pub. Date: Jun. 25, 2026

(54) SYSTEM AND METHOD FOR SEMI-SUPERVISED LEARNING OF TEMPORALLY CONSISTENT VIDEO SEGMENTATION

(71) Applicant: Samsung Electronics Co., Ltd., Gyeonggi-do (KR)

(72) Inventors: Mostafa EL-KHAMY, San Diego, CA (US); Kareem METWALY, San Diego, CA (US)

(21) Appl. No.: 19/358,940

(22) Filed: Oct. 15, 2025

Related U.S. Application Data
(60) Provisional application No. 63/738,576, filed on Dec. 24, 2024.

(51) Int. Cl. G06V 20/40; G06V 10/82

(52) U.S. Cl. CPC G06V 20/49; G06V 10/82; G06V 20/41

(57) ABSTRACT

A system and a method are disclosed. The method includes generating, for an input frame, a jittered version of the input frame by applying a computer-implemented image distortion operation to the input frame; performing temporal regularization by comparing segmentation predictions between the input frame and the jittered version of the input frame; and training a frame-level video segmentation network based on the temporal regularization.

### CROSS-REFERENCE TO RELATED APPLICATION

This application claims the priority benefit under 35 U.S.C. § 119(e) of U.S. Provisional Application No. 63/738,576, filed on Dec. 24, 2024, the entire contents of which are incorporated herein by reference.

### TECHNICAL FIELD

The disclosure generally relates to video segmentation and training. More particularly, the subject matter disclosed herein relates to improvements to semi-supervised training methods that produce temporally consistent segmentation outputs.

### SUMMARY

Video training is a common task in modern computer vision, encompassing video segmentation, video panoptic segmentation, video instance segmentation, video object detection, tracking, as well as other video processing techniques. While deep neural networks can achieve high accuracy on individual images, applying them directly across consecutive frames may lead to inconsistent predictions (“flicker”) caused by small variations or movements. These inconsistencies can negatively affect user experiences, particularly in real-time or visually sensitive applications.

To solve this problem, some existing approaches rely on processing entire videos in an offline manner, often using complex temporal refiners or multi-frame alignment. Such methods can capture frame-to-frame motion or context more effectively and reduce flicker. Other methods attempt to use fully annotated video datasets, requiring consistent dense labels for each frame, and may incorporate optical flow or attention-based modules to align consecutive frames.

One issue with the above approaches is that they can demand significant computational resources, making them impractical for resource-constrained devices or real-time deployment. Furthermore, most video datasets include only sparse temporal annotations, making it labor-intensive to collect the dense labels needed for multi-frame or temporal-refinement-based solutions. When large viewpoint shifts or rapid object motion occur, flow-based alignment or offline refiners may fail, leading to ghosting or undesired lag.

To overcome these issues, systems and methods are described herein for training video segmentation or object detection models that preserve temporal consistency without requiring dense annotations or high-complexity processing. By using single-frame models alongside synthetic distortions, such as slight translations, gamma variations, or occlusions, the disclosed approaches emulate inter-frame motion within individual images. Introducing a consistency loss that constrains predictions across these distorted frames helps maintain stable outputs across real video sequences, reducing flicker without relying on offline refinement.

The above approaches improve on previous methods because they minimize reliance on complex optical flow or temporal refiners, thereby decreasing both computational overhead and labeling requirements. By adopting single-frame models enhanced with consistency constraints, these techniques can provide efficient, frame-by-frame inference suitable for real-time and embedded settings, all while delivering temporally coherent predictions across consecutive frames.

According to an aspect of the disclosure, a method includes generating, for an input frame, a jittered version of the input frame by applying a computer-implemented image distortion operation to the input frame; performing temporal regularization by comparing segmentation predictions between the input frame and the jittered version of the input frame; and training a frame-level video segmentation network based on the temporal regularization.

According to another aspect of the disclosure, an apparatus includes a processor, and a memory storing instructions that, when executed by the processor, cause the apparatus to generate, for an input frame, a jittered version of the input frame by applying a computer-implemented image distortion operation to the input frame; perform temporal regularization by comparing segmentation predictions between the input frame and the jittered version of the input frame; and train a frame-level video segmentation network based on the temporal regularization.

### BRIEF DESCRIPTION OF THE DRAWING

In the following section, the aspects of the subject matter disclosed herein will be described with reference to exemplary embodiments illustrated in the figures, in which:

FIG. 1 is a block diagram illustrating a training mechanism for outputting a temporally consistent feature map, according to an embodiment;

FIG. 2 is a block diagram illustrating a temporally consistent video segmentation architecture, according to an embodiment;

FIG. 3 is a flowchart illustrating a method for improving temporal consistency via a learnable fusion tracking filter, according to an embodiment;

FIG. 4 is a block diagram of an electronic device in a network, according to an embodiment; and

FIG. 5 is a wireless communication system including a UE and a gNB, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Computer-implemented image distortion operation” as used herein refers to a process performed by a computing device to modify an image by applying one or more transformations to alter pixel values or spatial properties. Some examples of “computer-implemented image distortion operations” are translations, occlusions, gamma variations, blurring, sharpness adjustments, additive noise (e.g., Gaussian or Poisson noise), and/or rotation. These distortions may be applied to simulate real-world variations such as camera movement, lighting changes, or occlusions in video sequences.

“Temporal regularization” as used herein refers to a training technique that enforces consistency across multiple frames or between an original and a modified version of the same frame in a video processing pipeline. Some examples of “temporal regularization” are loss functions that constrain predictions to remain stable over time, methods that compare overlapping pixels in consecutive frames, and regularization terms that reduce flickering in video segmentation outputs. Temporal regularization may be applied using distance metrics such as L1, L2, cosine distance, or cross-entropy to ensure that small variations in input do not lead to abrupt changes in segmentation predictions.

“Segmentation predictions” as used herein refers to the output of a neural network or computer vision model that assigns labels or classifications to pixels or regions in an image or video frame. Some examples of “segmentation predictions” are pixel-wise class assignments for semantic segmentation, instance masks for object detection, and boundary maps for panoptic segmentation. Segmentation predictions may be represented as probability maps, softmax logits, or discrete labels that distinguish different objects or scene elements within a video frame.

“A frame-level image segmentation network” as used herein refers to a machine learning model or neural network that performs image segmentation on a per-frame basis without explicitly incorporating temporal dependencies across multiple frames. Some examples of “a frame-level image segmentation network” are convolutional neural networks (CNNs) trained for semantic segmentation, encoder-decoder architectures such as U-Net or DeepLab, and transformer-based models for pixel classification. A frame-level image segmentation network may process each frame independently while still being trained using temporal regularization techniques to improve consistency across video sequences.

A “jittered version of an input frame” as used herein refers to a modified version of an input frame that has been synthetically altered using one or more image distortion operations to simulate small variations in motion, lighting, or occlusion. Some examples of a “jittered version of the input frame” are a frame that has been slightly translated to emulate camera movement, a frame with gamma adjustments to mimic lighting changes, or a frame with random occlusions to simulate partial object obstruction. The jittered version of the input frame may be used during training to enforce temporal consistency by comparing its segmentation predictions to those of the original frame.

The present disclosure describes a semi-supervised training method for video understanding (training) tasks, including but not limited to video segmentation, video panoptic segmentation, video instance segmentation, video object detection, and tracking. Unlike other approaches, the disclosed method is capable of achieving temporally consistent outputs without requiring dense annotations per frame or multi-frame inputs. When such resources are available, the method may be orthogonal, and can be combined with other techniques to further improve cross-frame consistency. In addition, a single-frame network can be trained effectively using an image segmentation dataset, thereby minimizing the complexity often associated with full video annotation and multi-frame processing.

According to an embodiment, an aspect of the disclosure involves simulating small frame-to-frame variations, such as random translations, occlusions, and lighting adjustments, on still images. These synthetic distortions can emulate the slight movements and environmental changes typically observed in video data. A regularization loss can then be applied to enforce consistency between the original (non-distorted) frame outputs and the distorted frame outputs for overlapping pixel regions. This regularization can help the network produce stable predictions, thereby reducing flicker in real-world video applications.

Furthermore, according to an embodiment, an automated procedure is disclosed for selecting the trained checkpoint with the highest metric on a test dataset based on the highest temporal consistency when applied to a video test set. This approach may not rely on optical flow or any requirement to process multiple frames at once; rather, it explicitly enforces consistency through a new loss function that compares distorted and clean inputs. As a result, reduced flickering and more consistent segmentation results can be obtained while maintaining low computational overhead.

A system and method for training a video segmentation network to achieve temporally consistent outputs using an image segmentation dataset and a low-complexity, frame-based segmentation architecture are described. This approach may not require dense per-frame annotations or multi-frame input, yet it may remain compatible with such resources if they are available. The training strategy may introduce synthetic variations into still images in order to mimic slight movements or environmental changes typically observed in video sequences. These variations may include random translations, occlusions, and lighting modifications such as gamma adjustments, and they may be applied to create a “jittered” version of the original (which may be referred to as a weakly augmented) frame. The disclosed system and method improve consistency between frames by ensuring that overlapping pixels in the original frame and the jittered frame produce similar predictions, thereby reducing flicker when the trained network is deployed in real video segmentation scenarios.

According to an embodiment, given a single image or sequence of frames, the network may first be trained using standard image-segmentation losses (for example, cross-entropy or boundary loss). During training, Softmax logits may be calculated for the current undistorted (or weakly) augmented frame; for instance, if SegAugMix is employed as a baseline, that may serve as the weak augmentation of reference. Jitter can then be synthetically introduced to the input frame, using random translations, gamma variations, or random block occlusions to emulate movement or lighting changes. A semantic temporal intersection map may be generated to identify those pixels that share the same ground-truth label in both the undistorted and jittered frames (or, if available, an actual previous frame). The method also may add a loss term, referred to here as the temporal semantic loss (TSL), that compels the Softmax logits (or latent features) for overlapping pixels to be similar across the two frames. Various distance metrics may be applied, including L1, L2, cosine distance, and/or cross entropy. TSL may be calculated based on Equation 1:

$$TSL = L 2 ( soft\_volume ( i , j , t ) - soft\_volume ( i , j , t - 1 ) ) * IS\_True ( GT\_Label ( i , j , t ) == GT\_Label ( i , j , t - 1 ) ) \qquad Equation 1$$

where (i, j, t) represents the pixel location i, j in the current frame at time t, and (i, j, t−1) represents the corresponding location in the jittered or prior frame. The IS True operator may ensure that only pixels sharing the same ground-truth label contribute to the regularization.

In some cases, the original frame and the jittered frame may be almost identical aside from minor distortions like noise, gamma variation, or light augmentations (such as those provided by SegAugMix). Under these circumstances, nearly every pixel can be subject to TSL. This regularization can also be extended to multiple latent features, ensuring that intermediate feature maps at different stages of the network architecture remain coherent over slight changes in input. After training, temporal consistency may be evaluated on a set of validation videos by measuring flicker or stability metrics across consecutive frames, allowing identification of the checkpoint with the highest measured temporal stability. By using simple frame-by-frame networks and synthetic jitter, this solution may provide a means to achieve flicker-free video segmentation or other video understanding (training) tasks without incurring the complexities of multi-frame processing or fully annotated video datasets.

In practice, embodiments disclosed herein may be implemented in various computing devices that perform real-time video analysis and segmentation, including smartphones, autonomous vehicles, augmented reality (AR) systems, surveillance cameras, and robotic vision systems. These devices often require high accuracy in segmenting objects within a video stream while maintaining smooth and temporally consistent outputs. By applying synthetic distortions such as translations, occlusions, and lighting variations during training, the disclosed method enables frame-level image segmentation networks to generalize better to real-world conditions without the need for multi-frame input or dense annotations. This capability is particularly advantageous for low-power embedded devices, where computational efficiency and memory usage are carefully considered.

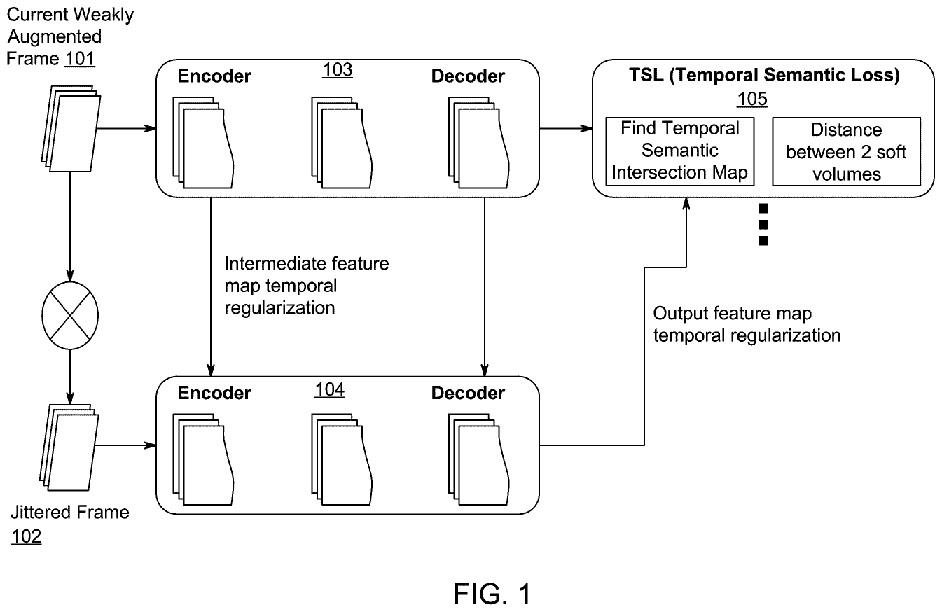

FIG. 1 is a block diagram illustrating a training mechanism for outputting a temporally consistent feature map, according to an embodiment.

Referring to FIG. 1, two separate inputs are shown, a current weakly augmented frame 101 and a jittered (or otherwise modified) frame 102, each passing through a similar encoder-decoder segmentation network. The upper pathway 103 processes the current frame, generating both intermediate feature maps in the encoder and segmentation outputs in the decoder. The lower pathway 104 processes the jittered frame, similarly producing its own intermediate feature maps and output.

A TSL module 105 then compares these two sets of representations. First, the module locates overlapping pixel regions that share the same semantic label, identified as the temporal semantic intersection map. Next, the TSL module measures the difference between corresponding soft volumes or feature maps (for example, using a distance metric such as L2 or cross entropy). In certain implementations, both intermediate features and final outputs can be regularized among the upper pathway 103 and the lower pathway 104 to reinforce consistency across frames. By enforcing alignment in overlapping regions, even when one frame is subject to slight translations, occlusions, or lighting changes, the system may improve stable segmentation predictions and reduce temporal flicker in real video applications.

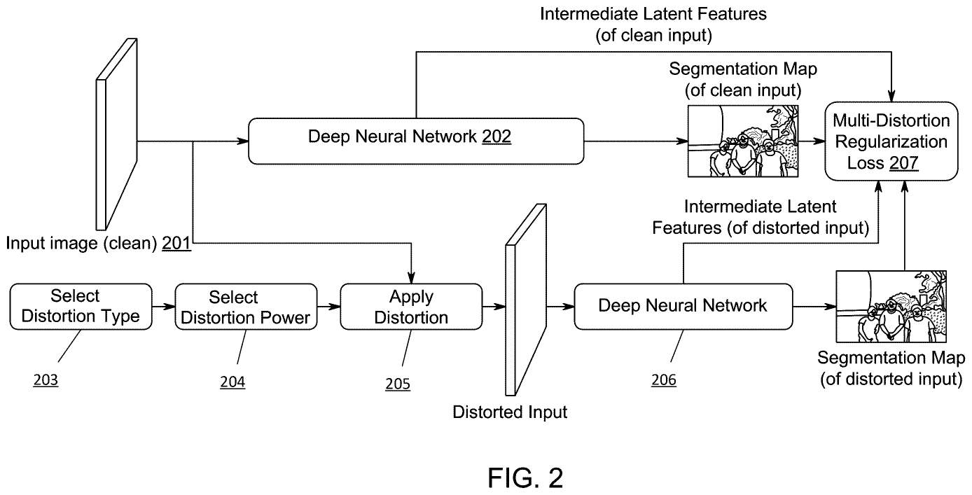

FIG. 2 is a block diagram illustrating a temporally consistent video segmentation architecture, according to an embodiment.

Referring to FIG. 2, a clean image (or video frame) 201 passes into a deep neural network 202, producing latent feature maps and a segmentation map. In parallel, a distortion pipeline is applied to the same clean input. This pipeline involves choosing a particular distortion type (for example, additive noise, blurring, or gamma adjustment) in block 203, and selecting a distortion “power” value from a predefined range in block 204, where higher power yields more pronounced alterations (generally resulting in lower peak signal-to-noise ratio (PSNR)). The distorted input is then applied to the input image in block 205, and propagates through a deep neural network 206, generating its own latent features and corresponding segmentation map.

A multi-distortion regularization loss term is determined in block 207, and encourages alignment between the outputs derived from the clean and distorted inputs. Depending on the distortion, this regularization may be applied to soft-volume predictions or intermediate feature representations. Certain distortions that involve geometric changes (such as translation or rotation) may also require corresponding modifications to the ground-truth labels. By systematically varying distortion types and strengths, the model learns robustness against a range of perturbations and maintains consistent predictions across different input conditions. In addition, in order to reduce flicker in video applications, the training process can involve monitoring temporal consistency. Checkpoints may be identified that yield minimal frame-to-frame fluctuation or flicker in validation sequences for deployment.

As discussed above, the disclosed system may apply L1 or L2 loss (among other possible distance metrics) to measure how much the network's predictions change when an input image is distorted. The distortion operation may be computer-implemented and can vary depending on the final desired predictions, for example it may be additive Gaussian noise/color jittering, Poisson noise, translation, gamma distortion, occlusion, blurriness, sharpness, and/or rotation. Some or all of the distortion operations can be combined. Additional or alternative distortion operations can also be used.

In the case of an additive Gaussian noise/color jittering distortion operation, a noise matrix may be generated to match the spatial dimensions of the input image, including all red green blue (RGB) channels, with mean zero and a specified standard deviation σ, which serves as the distortion “power.” A higher σ may lead to greater divergence from the original pixel values (and thus a lower PSNR). After the noise matrix is added to the clean input, the distorted image is clipped to remain within the permissible 0-255 intensity range for each pixel coordinate (x, y) and channel c. The distorted image may be given by Equation 2:

$$D ( x , y , c ) = max ( min ( I ( x , y , c ) + N ( x , y , c ) , 255 ) , 0 ) \qquad Equation 2$$

where D(x, y, c) is the final distorted image at spatial location (x, y) and RGB channel c.

The network can then generate predictions from both the clean image I and the distorted image D. The training loss can be described according to Equation 3:

$${L}_{gauss} ( y , {y}_{dist} ) = {\sum }_{x = 0}^{x < W} {\sum }_{y = 0}^{y < W} {\sum }_{c = 0}^{c < C} {α}_{l 1} \vert {y}_{dist} ( x , y , c ) - y ( x , y , c ) \vert + {{α}_{l 2} ( {y}_{dist} ( x , y , c ) - y ( x , y , c ) )}^{2} \qquad Equation 3$$

where y represents the network's predicted output (or intermediate feature maps) when the clean image I is provided as input, and y_{dist} represents the corresponding predictions when the distorted image D is used. The coefficients αₗ₁ and αₗ₂ determine relative weighting. This loss can be extended to multiple stages of the network, covering feature maps and final outputs, as expressed in Equation 4:

$${L}_{gauss}^{combined} = {\sum }_{l ∈ FeaturePool} {L}_{gauss} ( {y}^{l} , {y}_{dist}^{l} ) \qquad Equation 4$$

where FeaturePool refers to the set of all intermediate and final representations from which the training process can compute consistency between clean and distorted inputs. By adjusting σ and the chosen loss weights, the disclosed system can flexibly control how aggressively it enforces robustness against additive noise or color jittering.

In the case of a Poisson noise distortion operation, each pixel may be altered according to a Poisson distribution with parameter α*I(x, y, c), where α regulates the level of distortion. The distorted value at location (x, y) in channel c can be expressed based on Equation 5:

$$D ( x , y , c ) = max ( min ( \frac{1}{α} Poisson ( α * I ( x , y , c ) ) , 255 ) , 0 ) \qquad Equation 5$$

with the Poisson random variable drawn from the probability distribution of Equation 6:

$${P}_{poisson} ( k ) = \frac{{λ}^{k} {e}^{- λ}}{k !} \qquad Equation 6$$

where λ represents the Poisson parameter and k indicates the discrete outcome. The scaling factor α adjusts how heavily the underlying intensities are perturbed, thereby influencing the severity of the distortion. Following this operation, a similar loss formulation described for Gaussian noise can be applied for Poisson noise to encourage consistency between the network predictions on the clean and distorted inputs, as shown below in Equation 7:

$${L}_{poisson} = {\sum }_{x = 0}^{x < W} {\sum }_{y = 0}^{y < W} {\sum }_{c = 0}^{c < C} {α}_{l 1} \vert {y}_{dist} ( x , y , c ) - y ( x , y , c ) \vert + {{α}_{l 2} ( {y}_{dist} ( x , y , c ) - y ( x , y , c ) )}^{2} \qquad Equation 7$$

In the case of a translation distortion operation, the input image may be translated by small offsets in the horizontal and vertical directions to create the distorted output. Specifically, each pixel may be shifted by (kₓ, k_{y}), where kₓ and k_{y} are drawn from uniform distributions within predetermined ranges Uniform(−Kₓ, Kₓ) and Uniform(−K_{y}, K_{y}), respectively.

These values Kₓ and K_{y} define the “distortion power,” indicating how far and in what directions the image may be shifted. If a pixel's shifted coordinates fall outside the original image dimensions, the distorted image may be filled with a median intensity (for example, 128) to avoid undefined regions as shown below in Equation 8:

$$D ( x , y , c ) = \{ \begin{matrix}I ( x - {k}_{x} , y - {k}_{y} , c ) & if {k}_{x} < x < W and {k}_{y} < y < H \\ 128 & otherwise\end{matrix} \qquad Equation 8$$

Because this transformation modifies the spatial layout of the image, any associated label map should similarly be shifted. Pixels that move beyond the valid boundary in the label map may be assigned a value of 255, signaling that they should be ignored by the training loss. For example, ŷ_{dist}, which is a label map having been shifted in a similar way as the input image, may be given by Equation 9:

$${\hat{y}}_{dist} ( x , y , c ) = \{ \begin{matrix}\hat{y} ( x - {k}_{x} , y - {k}_{y} , c ) & if {k}_{x} < x < W and {k}_{y} < y < H \\ 255 & otherwise\end{matrix} \qquad Equation 9$$

When computing the multi-distortion regularization (MDR) loss for translation, the disclosed system may apply a loss only to pixel locations whose labels remain the same in both the original and translated frames. This can be applied via a 0 or 1 operator that becomes active if ŷ_{dist}(x, y) matches ŷ(x, y). Thus, the MDR loss term may be expressed according to Equation 10:

$${L}_{trans} = {\sum }_{x = 0}^{x < W} {\sum }_{y = 0}^{y < W} {\sum }_{c = 0}^{c < C} ( {α}_{l 1} \vert {y}_{dist} ( x , y , c ) - y ( x , y , c ) \vert + {{α}_{l 2} ( {y}_{dist} ( x , y , c ) - y ( x , y , c ) )}^{2} ) * {I}_{\{ {\hat{y}}_{dist} ( x , y ) = \hat{y} ( x , y ) \}} \qquad Equation 10$$

where ŷ_{dist}(x, y, c) and y(x, y, c) represent the network's predicted outputs (e.g., logits or features) from the distorted and original images, and αₗ₁ and αₗ₂ are weighting factors for the L1 and L2 components. The indicator function I may ensure that only regions sharing consistent labels between the distorted and original images contribute to the regularization term.

In the case of a gamma distortion operation, gamma correction can be expressed according to Equation 11:

$$\tilde{I} ( x , y , c ) = {I ( x , y , c )}^{γ} \qquad Equation 11$$

where γ is an exponent that adjusts image brightness.

In the disclosed approach, a distorted image D(x, y, c) may be generated as shown in Equation 12:

$$D ( x , y , c ) = max ( min ( {I ( x , y , c )}^{p \cdot γ + ( 1 - p ) \cdot \frac{1}{γ}} * {255}^{1 - ( p \cdot γ + ( 1 - p ) \cdot \frac{1}{γ} )} , 255 ) , 0 ) \qquad Equation 12$$

where p is drawn from a uniform distribution ∈{0,1}, γ is chosen from a predefined range ∈(0, Γ], and

$${255}^{1 - ( p \cdot γ + ( 1 - p ) \cdot \frac{1}{γ} )}$$

normalizes the resulting pixel values back into the 0 to 255 range. This may allow random toggling between gamma raise and gamma reduction, since p influences whether the exponent is applied directly as γ or in an inverted form 1/γ. Once the distorted image is produced, both the clean and distorted images can be passed through the model, and their outputs compared using a loss analogous to that employed for Gaussian distortions as shown in Equation 13:

$${L}_{gamma} = {\sum }_{x = 0}^{x < W} {\sum }_{y = 0}^{y < W} {\sum }_{c = 0}^{c < C} {α}_{l 1} \vert {y}_{dist} ( x , y , c ) - y ( x , y , c ) \vert + {{α}_{l 2} ( {y}_{dist} ( x , y , c ) - y ( x , y , c ) )}^{2} \qquad Equation 13$$

where y_{dist}(x, y, c) is the predicted soft-volume (or feature) for the distorted image, and y(x, y, c) is the corresponding prediction for the clean image. The parameters αₗ₁ and αₗ₂ determine how strongly each error component contributes, which can provide flexible control over the system's sensitivity to gamma-related changes.

In the case of an occlusion distortion operation, the image is distorted by randomly occluding portions of its pixel content, effectively mimicking “missing” regions or partial visibility. Although multiple occlusion methods exist, such as salt-and-pepper noise, the following approach may be used.

First, a random binary mask M may be generated at a resolution of

$$\frac{1}{{k}_{x}} W \times \frac{1}{{k}_{y}} H ,$$

where kₓ and k_{y} are randomly chosen within a specified range between 0 and Kₓ or K_{y}, respectively. This lower-resolution mask can then be upscaled to match the original image dimensions W×H, producing a set of binary values indicating which pixels will be occluded. The distorted image can be defined according to Equation 14:

$$D ( x , y , c ) = M ( x , y ) * I ( x , y , c ) \qquad Equation 14$$

where M(x, y) is 0 for occluded pixels and 1 for visible pixels, and I(x, y, c) is the original pixel value at coordinates (x, y) and channel c. By systematically applying mask-based occlusion, the disclosed system can compel the model to handle missing or obstructed content.

In the case of a blurriness distortion operation, blurriness can be introduced as a distortion by convolving the image with a Gaussian kernel. The degree of blur may depend on the kernel's window size k and its standard deviation σ, which together may determine the distortion “power.” An example implementation is shown in Equation 15:

$$D ( x , y , c ) = {\sum }_{i = - k}^{i < k} {\sum }_{i = - k}^{j < k} W ( i , j ) \cdot I ( x + i , y + j , c ) \qquad Equation 15$$

where (x, y) represents the spatial coordinates and c denotes the color channel. The weights W(i, j) may be computed using a Gaussian function as shown in Equation 16:

$$W ( i , j ) = \frac{1}{α} {e}^{\frac{- ( {i}^{2} + {j}^{2} )}{2 {σ}^{2}}} \qquad Equation 16$$

with α serving as a normalization factor to ensure the sum of all weights equals 1 as shown in Equation 17:

$${\sum }_{i = - k}^{i < k} {\sum }_{i = - k}^{j < k} W ( i , j ) = 1 \to α = {\sum }_{i = - k}^{i < k} {\sum }_{i = - k}^{j < k} {e}^{\frac{- ( {i}^{2} + {j}^{2} )}{2 {σ}^{2}}} \qquad Equation 17$$

Thus, a larger kernel size k or a higher σ parameter yields more pronounced blur, effectively simulating scenarios where the camera or subject is slightly out of focus.

In the case of a sharpness distortion operation, the system may introduce image sharpening as a distortion by applying a suitable convolution filter. One example uses the following filter in Equation 18:

$$w = [ \begin{matrix}0 & - 1 & 0 \\ - 1 & 5 & - 1 \\ 0 & - 1 & 0\end{matrix} ] \qquad Equation 18$$

This approach is not limited to this specific filter. A more general formulation may involve mixing the original pixel values with a blurred version of the image as shown in Equation 19:

$$D ( x , y , c ) = I ( x , y , c ) + α ( I ( x , y , c ) - {I}_{blurred} ( x , y , c ) ) \qquad Equation 19$$

where α controls the strength of the sharpening effect. A higher a may intensify the contrast between the original and blurred portions, resulting in a sharper final image.

In the case of a rotation distortion operation, a rotation distortion can be introduced by rotating the input image I by an angle θ sampled from a uniform distribution over the range ˜Uniform(−Θ, Θ). The parameter Θ thus can determine the distortion “power.” Any pixels that fall outside the valid image area after rotation can be filled with a median intensity value (for example, 128). Similarly, the associated ground-truth labels ŷ should be rotated by the same angle and padded with a designated out-of-range value (for example, 255) to ensure that these regions are excluded from the training loss as shown in Equation 20:

$${\hat{y}}_{dist} = Rotate ( \hat{y} , θ ) \qquad Equation 20$$

Because rotation alters the pixel layout similar to translation, a selective loss can be applied that regularizes only those pixels whose labels remain valid following the rotation as shown in Equation 21:

$${L}_{rotate} = {\sum }_{x = 0}^{x < W} {\sum }_{y = 0}^{y < W} {\sum }_{c = 0}^{c < C} ( {α}_{l 1} \vert {y}_{dist} ( x , y , c ) - y ( x , y , c ) \vert + {{α}_{l 2} ( {y}_{dist} ( x , y , c ) - y ( x , y , c ) )}^{2} ) * {I}_{\{ {\hat{y}}_{dist} ( x , y ) = \hat{y} ( x , y ) \}} \qquad Equation 21$$

where y_{dist}(x, y, c) and y(x, y, c) denote the predictions on the distorted and original inputs, respectively, and I_{{ŷ}_{_{dist}}_{(x,y)=ŷ(x,y)}} is an indicator function equaling 1 if the rotated label matches the unrotated label. This approach ensures that areas for which the label no longer aligns after rotation do not contribute to the loss.

During training, the overall loss function may combine a standard segmentation loss with one or more MDR terms. In one formulation, the total training loss can be expressed according to Equation 22:

$${L}_{total} = {α}_{seg} {L}_{seg} ( y , \hat{y} ) + α {L}_{MDR} ( y , {y}_{dist} , \hat{y} , {\hat{y}}_{dist} ) \qquad Equation 22$$

where L_{seg} denotes a segmentation loss (such as cross entropy or boundary loss) computed between the predicted output y and the ground-truth label ŷ, and L_{MDR} is an MDR term that measures consistency between predictions from clean and distorted inputs. Depending on the particular distortion type (e.g., translation or rotation), the labeled ground truth y may also require corresponding transformations to produce ŷ_{dist}, ensuring that pixels remain aligned for loss calculation.

In embodiments where multiple distortions are applied to a single input, the MDR term may be expanded as shown in Equation 23:

$${L}_{MDR} = {\sum }_{dist ∈ DistoritonPool} {α}_{dist} {L}_{dist} ( y , {y}_{dist} , \hat{y} , {\hat{y}}_{dist} ) \qquad Equation 23$$

where DistortionPool defines a set of distortion operations (for example, gamma adjustment, translation, rotation, or blurring). Each distortion can be assigned a weight α_{dist} that determines its relative impact on the overall regularization objective. By integrating both segmentation and distortion-based consistency losses, the disclosed system can learn robust segmentation models capable of handling various types and levels of data variation.

In some embodiments, a “warming” stage may be introduced during training to moderate the effects of multi-distortion in the early steps. This can be done by employing a scheduler for the distortion weights or intensities, so the system can ensure that the network initially focuses on accurate segmentation predictions without excessive alteration. Over successive training steps, the distortion terms may be incrementally increased or “saturated,” allowing the network to gradually adapt to more severe transformations. This staged approach can provide a foundation of stable feature learning before applying higher-intensity distortions, ultimately yielding more consistent performance across various input variations.

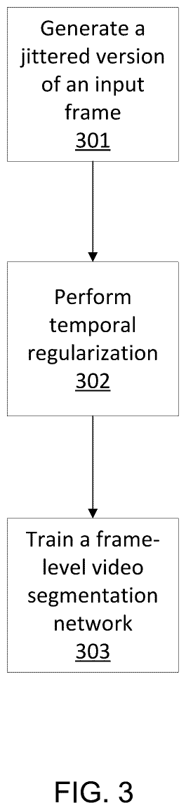

FIG. 3 is a flowchart illustrating a method for improving temporal consistency via a learnable fusion tracking filter, according to an embodiment.

Referring to FIG. 3, in step 301, a jittered version of an input frame is generated by applying a computer-implemented image distortion operation to the input frame. The image distortion operation may include one or more transformations such as translation, rotation, gamma adjustment, occlusion, or blur, which emulate the small frame-to-frame variations typically encountered in video sequences. This step may produce a jittered version of the frame that mimics slight camera or object motion, allowing the network to experience temporal perturbations during training while using only single-frame data.

In step 302, temporal regularization is performed by comparing segmentation predictions between the original input frame and the jittered version of the input frame. A consistency metric, such as an L1, L2, or cross-entropy loss, may be computed to quantify differences in predicted feature maps or soft volumes for corresponding pixel regions.

In step 303, a frame-level video segmentation network is trained based on the temporal regularization. The regularization loss may be incorporated into the overall training objective, allowing the network to adjust its parameters to minimize differences between the original and jittered frame predictions. Through repeated iterations of distortion generation, comparison, and optimization, the network may generate temporally consistent segmentation outputs when applied to real video sequences.

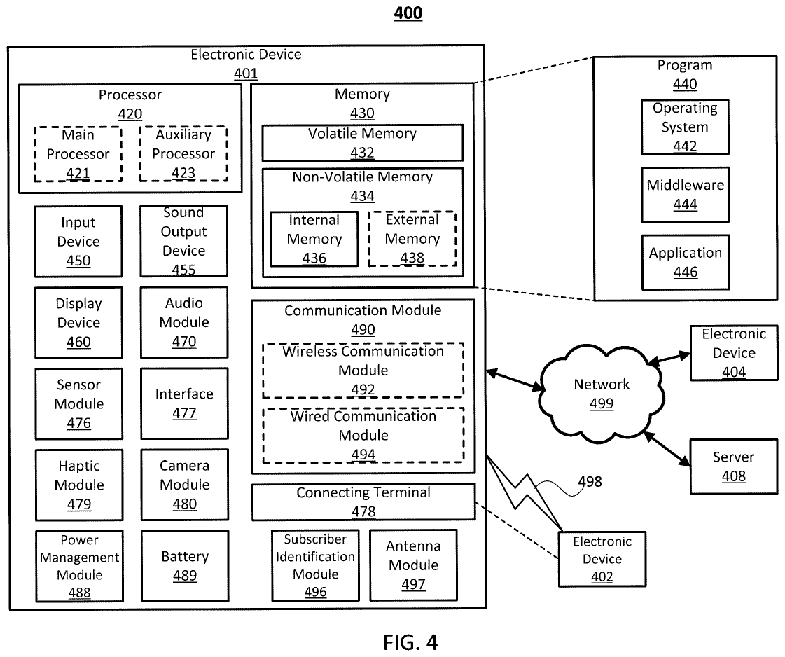

FIG. 4 is a block diagram of an electronic device in a network, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

Embodiments disclosed herein utilize the structural components of FIG. 4 to implement the training and temporal regularization mechanisms described in this application, enabling efficient and accurate video segmentation on resource-constrained devices such as smartphones, tablets, or other electronic systems. For example, a camera module 480 may capture a stream of video frames, which are then processed by the processor 420 to apply synthetic jitter, generate a jittered version of the input frame, and perform temporal regularization through the enforcement of a consistency loss. By using this training approach, temporal consistency is improved, reducing flicker and ensuring stable segmentation outputs across video frames.

The memory 430 may store the trained neural network parameters, loss functions, and intermediate feature representations required for segmenting video frames with temporal consistency. Additionally, memory 430 may retain historical segmentation data or previous feature maps, allowing the processor 420 to compare current and prior predictions, reinforce stability in overlapping pixel regions, and refine segmentation results. This local storage strategy enables the electronic device 401 to operate efficiently in real-time or near real-time without requiring cloud-based processing.

The communication module 490 may enable connectivity with external servers 408 or other devices 402/404, allowing updates to the segmentation model, refinement of training parameters, synchronization of segmented video outputs, or the exchange of additional data to support adaptive learning and improve model robustness over time.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

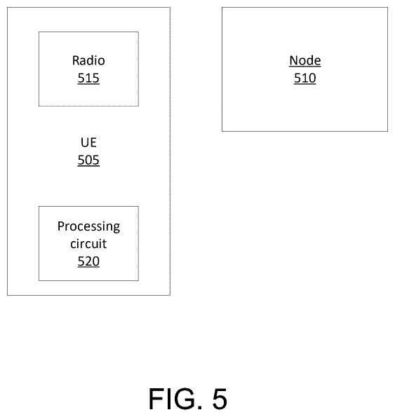

FIG. 5 is a wireless communication system including a UE and a gNB, according to an embodiment.

Referring to FIG. 5, a system including a UE 505 and a gNB 510, in communication with each other, is illustrated. The UE 505 may include a radio 515 and a processing circuit (or a means for processing) 520, which may perform various methods disclosed herein, e.g., the method illustrated in FIG. 3. For example, the processing circuit 520 may receive, via the radio 515, transmissions from the network node (gNB) 510, and the processing circuit 520 may transmit, via the radio 515, signals to the gNB 510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
generating, for an input frame, a jittered version of the input frame by applying a computer-implemented image distortion operation to the input frame;
performing temporal regularization by comparing segmentation predictions between the input frame and the jittered version of the input frame; and
training a frame-level video segmentation network based on the temporal regularization.

2. The method of claim 1, wherein the video segmentation network is trained without dense annotations for video frames or multi-frame video inputs.

3. The method of claim 1, wherein the jittering operation includes, at least one of, an additive Gaussian noise or color jittering operation, a Poisson noise operation, a translation operation, a gamma distortion operation, an occlusion operation, a blurriness operation, a sharpness operation, or a rotation operation.

4. The method of claim 1, further comprising generating a semantic temporal intersection map to identify pixel locations that share a same ground-truth label in both the input frame and the jittered version of the input frame.

5. The method of claim 4, further comprising applying a temporal semantic loss to constrain corresponding model outputs at the identified pixel locations.

6. The method of claim 1, wherein performing temporal regularization comprises enforcing a distance metric selected from L1, L2, cosine distance, or cross entropy to measure prediction discrepancies between the input frame and the jittered version of the input frame.

7. The method of claim 1, wherein training the frame-level video segmentation network includes capturing a plurality of checkpoints to identify a checkpoint corresponding to a highest temporal consistency metric across frames.

8. The method of claim 1, wherein the frame-level video segmentation network is a low-complexity network adapted to function without temporal refiners or optical-flow-based modules.

9. The method of claim 1, wherein the temporal regularization is performed at an intermediate feature map at an output of any network layer.

10. The method of claim 1, further comprising employing a warming stage during training, including setting distortion parameters to gradually increase over multiple training steps.

11. An apparatus comprising:
a processor; and
a memory storing instructions that, when executed by the processor, cause the apparatus to:
generate, for an input frame, a jittered version of the input frame by applying a computer-implemented image distortion operation to the input frame;
perform temporal regularization by comparing segmentation predictions between the input frame and the jittered version of the input frame; and
train a frame-level video segmentation network based on the temporal regularization.

12. The apparatus of claim 11, wherein the frame-level video segmentation network is trained without dense annotations for video frames or multi-frame video inputs.

13. The apparatus of claim 11, wherein the jittering operation includes at least one of an additive Gaussian noise or color jittering operation, a Poisson noise operation, a translation operation, a gamma distortion operation, an occlusion operation, a blurriness operation, a sharpness operation, or a rotation operation.

14. The apparatus of claim 11, wherein the processor is further configured to generate a semantic temporal intersection map to identify pixel locations that share a same ground-truth label in both the input frame and the jittered version of the input frame.

15. The apparatus of claim 14, wherein the processor is further configured to apply a temporal semantic loss to constrain corresponding model outputs at the identified pixel locations.

16. The apparatus of claim 11, wherein performing temporal regularization comprises enforcing a distance metric selected from L1, L2, cosine distance, or cross entropy to measure prediction discrepancies between the input frame and the jittered version of the input frame.

17. The apparatus of claim 11, wherein training the frame-level video segmentation network includes capturing a plurality of checkpoints to identify a checkpoint corresponding to a highest temporal consistency metric across frames.

18. The apparatus of claim 11, wherein the frame-level video segmentation network is a low-complexity network adapted to function without temporal refiners or optical-flow-based modules.

19. The apparatus of claim 11, wherein the temporal regularization is performed at an intermediate feature map at an output of any network layer.

20. The apparatus of claim 11, wherein the processor is further configured to employ a warming stage during training, including setting distortion parameters to gradually increase over multiple training steps.
